(19) United States
(12) Patent Application Publication
(10) Pub. No.: US 2025/0300405 A1
(43) Pub. Date: Sep. 25, 2025

(54) MINIATURIZED HIGH SPEED CONNECTOR

(71) Applicant: Amphenol Corporation, Wallingford, CT (US)

(72) Inventors: Jose Ricardo Paniagua, Newmarket, NH (US); Philip T. Stokoe, Attleboro, MA (US); Robert Richard, Nashua, NH (US); Marc Robert Charbonneau, Bedford, NH (US); Eric Leo, Nashua, NH (US)

(73) Assignee: Amphenol Corporation, Wallingford, CT (US)

(21) Appl. No.: 19/196,034

(22) Filed: May 1, 2025

Related U.S. Application Data
(63) Continuation of application No. PCT/US2023/078041, filed on Oct. 27, 2023.
(60) Provisional application No. 63/422,755, filed on Nov. 4, 2022.
(60) Provisional application No. 63/459,548, filed on Apr. 14, 2023.

(51) Int. Cl. H01R 13/6587; H01R 12/71; H01R 13/514; H01R 13/652; H01R 13/6594

(52) U.S. Cl. CPC H01R 13/6587; H01R 12/714; H01R 12/716; H01R 13/652; H01R 13/6594; H01R 13/514

(57) ABSTRACT

A miniaturized high-speed connector. The connector may include signal and ground conductors within each of multiple columns that are mounted to a PCB using different techniques. Multiple ground conductors may be indirectly connected to the PCB though a conductive contact member, enabling multiple ground conductors within the connector to be coupled to ground structures withing the PCB. Space within the interconnection system for individual ground tails may therefore be saved. Alternatively or additionally, ground structures may be constructed from components of different properties, such as thickness or yield strength, to provide desired mechanical property. Lossy material may be coupled to portions of those components where they bound a gap resulting from joining two of the components.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, such as printed circuit boards (“PCBs”), which may be joined together with electrical connectors. A known arrangement for joining several printed circuit boards is to have one printed circuit board serve as a backplane. Other printed circuit boards, called “daughterboards” or “daughtercards,” may be connected through the backplane.

A known backplane is a printed circuit board onto which many connectors may be mounted. Conducting traces in the backplane may be electrically connected to signal conductors in the connectors so that signals may be routed between the connectors. Daughtercards may also have connectors mounted thereon. The connectors mounted on a daughtercard may be plugged into the connectors mounted on the backplane. In this way, signals may be routed among the daughtercards through the backplane. The daughtercards may plug into the backplane at a right angle. The connectors used for these applications may therefore include a right angle bend and are often called “right angle connectors.”

Connectors may also be used in other configurations for interconnecting printed circuit boards and for interconnecting other types of devices, such as cables, to printed circuit boards. For example, printed circuit boards may sometimes be aligned in parallel. Connectors used to connect these boards are often called “stacking connectors” or “mezzanine connectors.” As another example, some systems use a midplane configuration. Similar to a backplane, a midplane has connectors mounted on one surface that are interconnected by conductive traces within the midplane. The midplane additionally has connectors mounted on a second side so that daughtercards are inserted into both sides of the midplane.

The daughtercards inserted from opposite sides of the midplane often have orthogonal orientations. This orientation positions one edge of each printed circuit board adjacent the edge of every board inserted into the opposite side of the midplane. The traces within the midplane connecting the boards on one side of the midplane to boards on the other side of the midplane can be short, leading to desirable signal integrity properties.

A variation on the midplane configuration is called “direct attach.” In this configuration, daughtercards are inserted from opposite sides of a rack enclosing printed circuit boards of a system. These boards likewise are oriented orthogonally so that the edge of a board inserted from one side of the rack is adjacent to the edges of the boards inserted from the opposite side of the system. These daughtercards also have connectors. However, rather than plugging into connectors on a midplane, the connectors on each daughtercard plug directly into connectors on printed circuit boards inserted from the opposite side of the system. Connectors for this configuration are sometimes called direct attach orthogonal connectors. Examples of direct attach orthogonal connectors are shown in U.S. Pat. Nos. 7,354,274, 7,331,830, 8,678,860, 8,057,267 and 8,251,745.

Regardless of the exact application, electrical connector designs have been adapted to mirror trends in the electronics industry. Electronic systems generally have gotten smaller, faster, and functionally more complex. Because of these changes, the number of circuits in a given area of an electronic system, along with the frequencies at which the circuits operate, have increased significantly in recent years. Current systems pass more data between printed circuit boards and require electrical connectors that are electrically capable of handling more data at higher speeds than connectors of even a few years ago.

In a high density, high speed connector, electrical conductors may be so close to each other that there may be electrical interference between adjacent signal conductors. To reduce interference, and to otherwise provide desirable electrical properties, shield members are often placed between or around adjacent signal conductors. The shields may prevent signals carried on one conductor from creating “crosstalk” on another conductor. The shield may also impact the impedance of each conductor, which may further contribute to desirable electrical properties.

Examples of shielding can be found in U.S. Pat. Nos. 4,632,476 and 4,806,107, which show connector designs in which shields are used between columns of signal contacts. These patents describe connectors in which the shields run parallel to the signal contacts through both the daughterboard connector and the backplane connector. Cantilevered beams are used to make electrical contact between the shield and the backplane connectors. U.S. Pat. Nos. 5,433,617, 5,429,521, 5,429,520, and 5,433,618 show a similar arrangement, although the electrical connection between the backplane and shield is made with a spring type contact. Shields with torsional beam contacts are used in the connectors described in U.S. Pat. No. 5,980,321. Further shields are shown in U.S. Pat. Nos. 9,004,942, 9,705,255.

Other techniques may be used to control the performance of a connector. For instance, transmitting signals differentially may also reduce crosstalk. Differential signals are carried on a pair of conducting paths, called a “differential pair.” The voltage difference between the conductive paths represents the signal. In general, a differential pair is designed with preferential coupling between the conducting paths of the pair. For example, the two conducting paths of a differential pair may be arranged to run closer to each other than to adjacent signal paths in the connector. No shielding is desired between the conducting paths of the pair, but shielding may be used between differential pairs. Electrical connectors can be designed for differential signals as well as for single-ended signals. Examples of differential electrical connectors are shown in U.S. Pat. Nos. 6,293,827, 6,503, 103, 6,776,659, 7,163,421, and 7,794,278.

Electrically lossy material has also been used to improve performance of an electrical connector. Examples of electrical connectors incorporating lossy material are shown in U.S. Pat. Nos. 7,371,117 and 8,371,875.

### SUMMARY

Multiple aspects of a high speed, high density interconnection system are described. In one aspect, a small connector may be achieved with multiple ground leads connecting to a conductive member extending parallel to the mounting interface. The connector may have multiple parallel columns of conductors, with each column fitting within a volume on the order of 400-600 mm³, which may be 10-15 mm by 20-35 mm by 2-5 mm. For example, a column may fit in a volume of approximately 400 mm³ with dimensions of approximately 10 mm×20 mm×2 mm. The conductive member may be connected to ground structures in a printed circuit board (PCB) to which the connector is mounted. In another example, shields may be formed of multiple components of different thicknesses and/or materials, that are electrically and mechanically connected. One component, for example, may be a thin plate providing shielding and another component may be or incorporate a compliant beam serving as a contact for the shield. In another aspect, performance of the connector may be improved by including lossy material may be positioned to electrically coupled to components forming portions of the connector ground structure that are separated by a small gap. The lossy material, for example, may be lossy ink or conductive ink coated onto either or both of those components of the ground structure. Lossy ink may be made in the same way as conductive ink but either applied thin enough that it is lossy or is formulated with a low concentration of conductive materials that it is a lossy conductor.

Some embodiments provide an electrical connector with a mounting interface for high-frequency and high-density connection to a printed circuit board (PCB). The electrical connector comprises: a plurality of signal conductors, each of the plurality of signal conductors having an end at the mounting interface, wherein the end is configured for connection to the PCB; a plurality of ground conductors, each of the plurality of ground conductors having an end at the mounting interface; and a conductive contact member comprising a contact configured for connection to a ground structure of the PCB; wherein: the ends of the plurality of ground conductors are connected to the conductive contact member.

In some embodiments, the conductive contact member comprises a plurality of openings; and the ends of the plurality of ground conductors are stubs engaged within the plurality of openings of the conductive contact member. In some embodiments, the conductive contact member comprises a metal sheet. In some embodiments, the conductive contact member comprises a plurality of conductive plates; and the ends of the plurality of ground conductors are connected to plates of the plurality of conductive plates.

In some embodiments, the electrical connector further comprises a plurality of ground structures comprising tails at the mounting interface, the tails of the plurality of ground structures passing through the conductive contact member. In some embodiments, the conductive contact member comprises a plurality of conductive plates; the ends of the plurality of ground conductors are connected to plates of the plurality of conductive plates; and the tails of the plurality of ground structures pass through the plates of the plurality of conductive plates. In some embodiments, tails of the plurality of ground structures are electrically coupled to the conductive contact member. In some embodiments, the plurality of ground structures are conductive shields for the plurality of signal conductors.

In some embodiments, the contact of the conductive contact member comprises a spring finger. In some embodiments, the ends of the plurality of signal conductors pass through the conductive contact member and comprise press fits. In some embodiments, the plurality of signal conductors and the plurality ground conductors are disposed in a plurality of parallel columns; and within each column of the plurality of columns, signal conductors of the plurality of signal conductors are disposed between and adjacent to ground conductors of the plurality of ground conductors.

In some embodiments, the plurality of signal conductors and the plurality of ground conductors are disposed in a plurality of columns with each column comprising pairs of conductive signal conductors with ground conductors of the plurality of ground conductors between the pairs of signal conductors. In some embodiments, the ends of the ground conductors of the plurality of columns are connected to the conductive contact member. In some embodiments, the center-to-center spacing of pairs of signal conductors along each of the plurality of columns is less than 2.5 millimeters. In some embodiments, a linear density of pairs of signal conductors along each of the plurality of columns is between 10 and 60 pairs of signal conductors per centimeter. In some embodiments, a linear density of pairs of signal conductors along each of the plurality of columns is approximately 5 pairs of signal conductors per cubic centimeter. In some embodiments, the electrical connector provides a data rate between 32 Gb/s and 128 Gb/s.

Some embodiments provide an electrical assembly. The electrical assembly comprises: a PCB; and an electrical connector mated with the PCB through, the electrical connector comprising: a mounting interface with the PCB; a plurality of signal conductors, each of the plurality of signal conductors having an end at the mounting interface connected to the PCB; a plurality of ground conductors, each of the plurality of ground conductors having an end at the mounting interface; and a conductive contact member comprising a contact connected to a ground structure of the PCB; wherein: the ends of the plurality of ground conductors are connected to the conductive contact member.

In some embodiments, the PCB comprises a plurality of openings; and the ends of the plurality of signal conductors are engaged with the plurality of openings of the PCB. In some embodiments, the ground structure of the PCB comprises a surface of the PCB; and
the contact is pressed against the surface of the PCB. In some embodiments, the PCB comprises a plurality of openings; the electrical connector comprises a plurality of ground structures with tails at the mounting interface with the PCB; and tails of the plurality of ground structures are engaged with the plurality of openings of the PCB.

In some embodiments, the plurality of signal conductors and the plurality of ground conductors are disposed in a plurality of columns with each column comprising pairs of conductive signal conductors with ground conductors of the plurality of ground conductors between the pairs of signal conductors. In some embodiments, the plurality of signal conductors are disposed in a plurality of openings of the PCB arranged in a plurality of columns.

Some embodiments provide an electrical connector. The electrical connector comprises: a shield comprising: a first component composed of a first material, the first component including one or more contact portions; and a plate composed of a second material different from the first material, wherein the first component is electrically and mechanically connected to the plate.

In some embodiments, the first component and the plate are welded together. In some embodiments, the one or more contact portions consists of two contact portions.

In some embodiments, the first portion is separated from the plate by a gap over at least a portion of the shield; and the electrical connector further comprises lossy material electrically coupled to a portion of the first component and/or the plate bounding the gap.

In some embodiments, the lossy material is inside the gap between the first component and the plate. In some embodiments, the lossy material is outside the gap between the first component and the plate. In some embodiments, the electrical connector comprises a housing comprising a surface; the shield is held within the housing with the surface adjacent the shield; and the lossy material is attached to the housing and electrically coupled to the shield at the surface. In some embodiments, the housing comprises an insulative member and the lossy material is attached to the insulative member. In some embodiments, the housing comprises plastic filled with conductive particles. In some embodiments, the lossy material is coated on a surface of a portion of at least one of the first component and the plate bounding the gap.

In some embodiments, the lossy material is carbon resistive ink. In some embodiments, the carbon resistive ink has a volume resistivity of approximately 0.5 Ohms centimeter. In some embodiments, the lossy material is a silicone-based conductive ink. In some embodiments, the silicon-based conductive ink has a sheet resistance of approximately 0.05 Ohms/sq/mil. In some embodiments, the lossy material is an electrically conductive adhesive transfer tape. In some embodiments, the electrically conductive adhesive transfer tape has a resistance of less than 2.5 Ohms per square inch of tape. In some embodiments, the lossy material is plastic filled with conductive particles adjacent a surface of the portion of the first component and/or the plate bounding the gap.

In some embodiments, the shield is a first shield, the electrical connector comprises a plurality of shields, including the first shield, each of the plurality of shields comprising: a first component composed of the first material, the first component including one or more contact portions; and a plate composed of the second material, wherein the first component is electrically and mechanically connected to the plate. In some embodiments, the one or more contact portions are configured to generate a contact pressure in excess of 100 psi. In some embodiments, the first component has a Young's Modulus of approximately 18,900,000 psi. In some embodiments, the electrical connector has an insertion loss of less than 1.5 dB in a frequency range of approximately 25 GHz to 30 GHz.

Some embodiments provide an electrical connector with a mounting interface for high-frequency and high-density connection. The electrical connector comprises: a plurality of signal conductors; a plurality of ground conductors; and a plurality of shields surrounding sets of signal conductors of the plurality of signal conductors and ground conductors of the plurality of ground conductors, each of the plurality of shields comprising: a first component composed of a first material, the first component including one or more contact portions; and a plate composed of a second material different from the first material, wherein the first component is electrically and mechanically connected to the plate.

In some embodiments, the first component and the plate are welded together. In some embodiments, the one or more contact portions consist of two contact beams. In some embodiments, for each of the plurality of shields: over at least a portion of the shield, the first portion is separated from the plate by a gap; and the shield further comprises lossy material electrically coupled to a portion of the first component and/or the plate bounding the gap.

Some embodiments provide an electrical connector. The electrical connector comprises: a ground structure comprising: a first component; a second component, wherein the second component is attached to the first component with a gap bounded by the first component and the second component over at least a portion of the first component and at least a portion of the second component; and lossy material electrically coupled to the at least the portion of the first component and/or the at least the portion of the second component bounding the gap.

In some embodiments, the first component and the second component are welded together. In some embodiments, the first component comprises a compliant member comprising a contact portion.

In some embodiments, the lossy material is inside the gap between the first component and the plate. In some embodiments, the lossy material is coated on a surface of at least one of the first component and the second component in a region bounding the gap. In some embodiments, the lossy material is carbon resistive ink. In some embodiments, the carbon resistive ink has a volume resistivity of approximately 0.5 Ohms centimeter.

In some embodiments, the electrical connector comprises a housing comprising a surface; the second component is held within the housing adjacent to the surface; and the lossy material is disposed within the housing at the surface and electrically coupled to the second component. In some embodiments, the housing comprises an insulative member and the lossy material is attached to the insulative member. In some embodiments, the surface of the housing comprises plastic filled with conductive particles.

In some embodiments, the lossy material is a silicone-based conductive ink. In some embodiments, the silicon-based conductive ink has a sheet resistance of approximately 0.05 Ohms/sq/mil. In some embodiments, the lossy material is an electrically conductive adhesive transfer tape. In some embodiments, the electrically conductive adhesive transfer tape has a resistance of less than 2.5 Ohms per square inch of tape.

Some embodiments provide an electrical connector. The electrical connector comprises: a ground structure comprising: a first component; a second component, wherein the second component is attached to the first component with a gap bounded by the first component and the second component over at least a portion of the first component and at least a portion of the second component; and lossy material within the gap bounded by the first component and the second component.

These techniques may be used alone or in any suitable combination. The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B depict an interconnection system 100, with a daughter card connector 110 and a backplane connector 120 in mated and unmated states, respectively, according to some embodiments.

FIGS. 2A and 2B shows various components of the daughter card connector 110 of the interconnection system 100 of FIGS. 1A-1B, according to some embodiments.

FIG. 3A is a perspective view of the organizer assembly of FIG. 2B, according to some embodiments.

FIG. 3B is an exploded view of the organizer assembly 112, according to some embodiments.

FIG. 4 is an enlarged cross-sectional view of a mounting interface 400 of a daughter connector mounted to a PCB, according to some embodiments, with contacts 302 in an uncompressed state shown superimposed on the PCB.

FIG. 5A is a perspective view of a wafer 113 of the daughter card connector 110 of FIGS. 1A-1B, according to some embodiments.

FIG. 5B is an exploded view of the wafer 113 of FIG. 5A, according to some embodiments.

FIG. 6 is an exploded view of the lead frame assembly 502 of FIG. 5A, showing a lead frame 602 separate from an over mold 604, according to some embodiments.

FIG. 7A is a perspective view of a connector module 700 comprising four wafers and an organizer assembly 112 of the daughter card connector 110, according to some embodiments.

FIG. 7B is side view of a wafer 113 of the connector module, without organizer assembly 112 in place.

FIG. 7C is a bottom plan view of the wafer 113, showing the mounting interface.

FIG. 8A is a bottom plan view of a portion of a mounting interface of the connector module of FIGS. 7A-7B, with metal plate 308 removed, according to some embodiments.

FIG. 8B is an enlarged bottom plan view of a portion of a mounting interface 800 of the daughter card connector 110 of FIGS. 8A with metal plate 308 removed, and a portion of plastic layer 306 cut away, according to some embodiments.

FIG. 8C is a perspective view of the portion of a mounting interface 800 of FIGS. 8B.

FIG. 9 is a bottom plan view of the portion of the mounting interface 800 of FIG. 8A with plate 308 in place, according to some embodiments.

FIG. 10 is an enlarged cross-sectional view of a portion of a connector module 700, taken along line 10-10 in FIG. 7A, and revealing a cross shield assembly 508, according to some embodiments.

FIG. 11A is a top plan view of the cross shield assembly 508 of FIG. 10, according to some embodiments.

FIG. 11B is a bottom plan view of the cross shield assembly 508 showing a plate 1112, according to some embodiments.

FIG. 11C is a side view of the cross shield assembly 508 of FIGS. 11A-11B, according to some embodiments.

FIGS. 11D and 11E are side views of the cross shield assembly 508 of FIGS. 11A-11B, illustrating options for placement of lossy material adjacent a gap.

FIG. 12 is a graph showing simulated loss of a signal in a cross shield including lossy material, according to some embodiments.

FIG. 13 is a graph illustrating simulated signal strengths through a connector with a cross shield including lossy material constructed according to some embodiments and a connector without a cross shield including lossy material.

FIG. 14 is a graph illustrating simulated loss in signal strength through a connector with a cross shield including lossy material constructed according to some embodiments and a connector without a cross shield including lossy material.

### DETAILED DESCRIPTION

The inventors have recognized and appreciated connector designs that provide for small electrical connectors that support a high density interconnection system carrying high frequency signals used to support high data rates. Some embodiments may allow for a signal conductor density of up to 5 pairs of signal conductors per cubic centimeter or 60 pairs per centimeter. The connector, for example, may have multiple parallel columns of conductors, with each column fitting within a volume on the order of 530 mm³, which may be approximately 12 mm×22 mm×2 mm. Each such column may have between 2 to 12 signal pairs. Despite such a high density of interconnects, each signal pair may support high data rates, such as data rates greater than 100 gigabits per second (Gb/s).

Such a connector may have grounding structures that reduce the amount of space within the interconnection system needed for ground conductors, and thus allow for a greater signal conductor density while providing high signal integrity. Conventional electrical connectors have ground conductors that end with tails at a mounting interface configured to connect the ground conductors to ground structures within a printed circuit board (PCB) to which the connector is mounted. Pressfit tails are often desired because connectors with pressfit tails for both signal and ground conductors may be easily mounted to a PCB by pressing the connector onto the PCB. Additionally, the connector can be pulled off the PCB, which enables rework of a PCB assembly during manufacture or repair after the PCB assembly is fielded.

In some connectors, high frequency performance and high density may be facilitated by having ground conductors interspersed with signal conductors in multiple columns. Optionally, planar shields may be positioned between the columns. The inventors have recognized and appreciated techniques that enable the performance benefits of grounding conductors while reducing the amount of space required in the electrical connector associated with conventional tails at the mounting interface. These techniques may preserve the benefits of pressfit mounting for all signal and ground conductors but require less area on the surface of a PCB to connect all of the ground conductors to ground structures within the PCB, reducing the area and the volume of the connector.

In one aspect, multiple ground conductors may be connected at a mounting interface to a conductive contact member, which connects to ground of a PCB when the electrical connector is mounted to the PCB. The ground conductors may be stamped as part of the same lead frame as signal conductors, which may have pressfit tails. The signal conductors and ground conductors of the lead frame, for example, may form a column of contacts in the connector. Within the column, conductors carrying a signal may be between two ground conductors. In a connector configured for differential signals, for example, pairs of signal conductors suitable for carrying differential signals may be between and adjacent to two ground conductors in the same column.

The conductive contact member may engage a ground structure on the PCB when the connector is pressfit onto the PCB. For example, the conductive contact member may have compliant contacts that are deflected to generate contact force on a ground pad on a surface of the PCB when the connector is pressfit onto the PCB. The force to press the conductive contact member against the ground pads on the surface may be generated by securing the connector to the PCB with the conductive contact member in a compressed state. The connector may be secured by the pressfit tails of the signal conductors and/or pressfit tails of shields and/or other structures, such as mounting posts or hold downs.

Ground conductors may be connected directly or indirectly to the conductive contact member. Each ground conductor in the lead assembly may terminate in a structure for engaging the conductive contact member. The conductive contact member may have complementary structures so that the ground conductors engage with the conductive contact member(s). For example, the ground conductors may end with stubs that engage one or more conductive plates, serving as the conductive contact member(s). As another example, the conductive plates may have openings aligned with the stubs of ground conductors that are sized to form an interference fit between the ground conductors and the conductive plate. The ground conductors in one or more columns may be connected to the same conductive plate while the tails of the signal conductors in those columns may pass through the plate. As another example, the connector may include a lossy member with openings aligned with the stubs of ground conductors that are sized to form an interference fit between the ground conductors and the lossy member. In this example, the lossy member may be in contact with the conductive plate.

Alternatively or additionally, ground conductors in the lead assembly may be indirectly coupled to the conductive contact member through one or more conductive or lossy members. For example, plastic filled with or plated with conductive material may contact or couple to the ground conductors and the conductive contact member. The filler or plating may be present in quantities that provide a conductive or lossy coupling.

The conductive plate, in turn, may be coupled to a ground structure of a PCB. The conductive plate may be pressure mounted to the PCB, for example, making contact to a ground pad on the surface of the PCB. A pressure mounted connection may be made when other conductive members within the connector are connected to the PCB through pressfits inserted into vias on the PCB. In some examples, a plurality of conductive fingers may be cut from the conductive plate and bent into beams that press against the surface of the PCB when the connector is mounted to the PCB. The ground conductors are thus connected to the ground structure of the PCB through the conductive contact member.

By eliminating tails for ground conductors, corresponding vias within the PCB for connection to ground tails can also be eliminated. As PCBs must be manufactured with clearance around each via, avoiding individual vias for each ground conductors reduces the area within the PCB for mounting the connector by the area of the eliminated vias as well as the required clearance around those vias. Moreover, as tails for conductors in a connector are frequently formed as pressfits, which have widened distal ends that are compressed upon insertion in a via, terminating the ground conductors to a conductive plate, without a pressfit, also frees up space within the connector for signal conductors.

As a result of these reductions, the size of the connector may be reduced in comparison to a connector with conventional ground connections to a PCB. Such a size reduction may be achieved even when the signal conductors or other conductors within the connector have pressfits or tails in other configurations for mounting to a PCB.

The inventors have recognized and appreciated that such size reduction may be particularly advantageous when the ground conductors that terminate in stubs, rather than press fits, are in a column with signal conductors that terminate in pressfits. Accordingly, a conductive contact member may be used to connect grounds in columns with press fit signal conductors to ground while shields between the columns may include pressfit tails. The pressfit tails on the shields may provide electrical as well as mechanical benefits without requiring the connector to be as large as would be required for pressfit contact tails on ground conductors in line with signal conductors.

Further, the inventors have further recognized and appreciated techniques that simultaneously provide desirable electrical and mechanical characteristics at a mating interface of a miniaturized connector. Ground structures of the connector may be made of multiple components that may have different physical characteristics. The components, for example, may have different thicknesses or may be formed of different materials. A first component, for example, may be thinner and a second component may be thicker. The thinner component may extend over a relatively large area, serving as a shield. The thin material may facilitate miniaturization. The second component may incorporate compliant structures, such as beams to make electrical connections to the shield. Alternatively or additionally, one of the components may be formed of a more conductive material than the other. The more conductive component may extend over a relatively large area, providing shielding. The less conductive component, for example, may be formed of a material with a higher yield strength and may provide a more reliable contact than a contact of similar shape formed with the more conductive material.

This technique may be applied to cross shields, which may be integrated into the connector at the mating interface of the connector. The cross shields, for example, may separate the mating portions of conductors that carry separate signals. In some examples, the cross shields may be generally planar and may be within planes that are orthogonal to the column direction of the connector. Such designs may ensure that contact members (e.g., beams) of the cross shields make reliable contact with corresponding ground elements. In general, the contact members should press firmly against a corresponding element to maintain reliable electrical contact. A cross shield comprising two different components may use materials selected to provide a desired conductivity and a reliable electrical connection between contact members of a cross shield and their corresponding ground elements. For example, the material of the portion with the contact members may be selected such that contact members press against corresponding ground elements with a desired force to ensure reliable electrical contact.

The inventors have further recognized and ameliorated a condition that might otherwise degrade signal integrity when two components are used in the ground system of a high-speed connector. When two or more components are combined as part of the ground system, there may be a gap between two components, which may resonate at frequencies within the operating range of a high-speed connector. The inventors have recognized and appreciated that lossy material electrically coupled to the two components near the gap mitigates that resonance. Coupling may result from direct contact or from positioning the lossy material in close proximity to the components bounding the gap. In some examples, the lossy material may be lossy ink, conductive ink or other material that can be applied in a thin layer. That material might be deposited on the components that bound the gap. For sufficiently thin material, such as might be applied as an ink, the lossy material might be deposited within the gap itself. Alternatively or additionally, the ink or other lossy material may be outside the gap, but adjacent the portions of the components that bound the gap. The lossy material, for example, may be coated on the components outside the gap or may be integrated into a portion of a housing for the connector holding the components. The lossy material mitigates loss in performance caused by the gap in a shield, such as a cross shield.

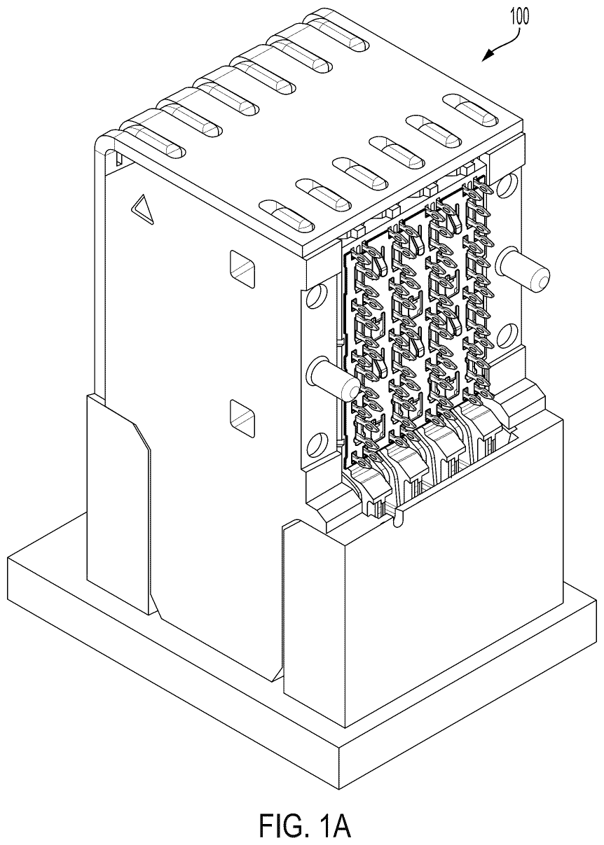

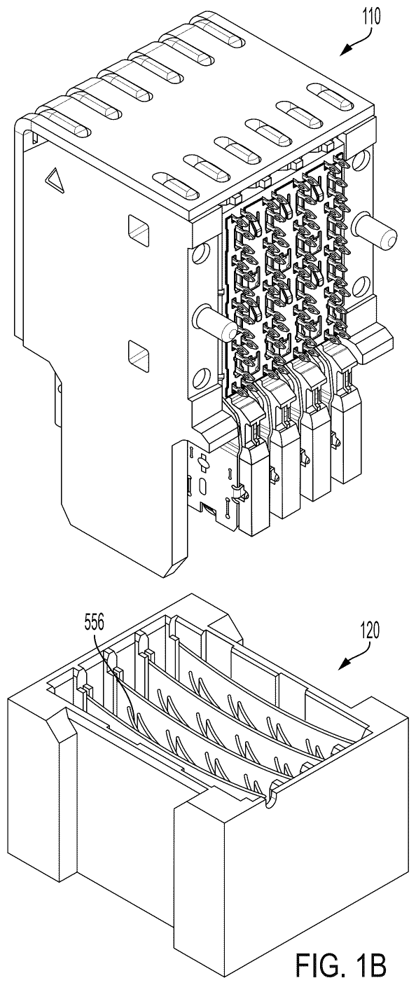

The foregoing techniques may be used separately or together in any suitable combination. FIGS. 1A and 1B depict an exemplary interconnection system 100 in which the above-described techniques are used together. The interconnection system 100 may include two assemblies. In the example embodiment of FIGS. 1A-1B, a first of the assemblies is a daughter card connector 110 which is electrically connected to a mating connector. In the example of FIGS. 1A-1B, the second of the two assemblies is a backplane connector 120. The daughter card connector 110 is configured to attach to the backplane connector 120. In this example, techniques for reducing the size of the connectors while enabling high frequency performance are described with respect to daughter card connector 110. However, it should be appreciated that these techniques may alternatively or additionally be applied with respect to backplane connector 120 or connectors of other configurations.

The daughter card connector 110 may be configured to be mounted to a printed circuit board (PCB), e.g. PCB 115 and to mate with a mating connector, here illustrated as backplane connector 120. The daughter card connector 110 may include conductors that make connections between the PCB and the mating connector. For this purpose, each of the conductors may have a mating portion, which may be positioned at one end of the conductor, for mating with a corresponding mating portion of a conductor in backplane connector 120.

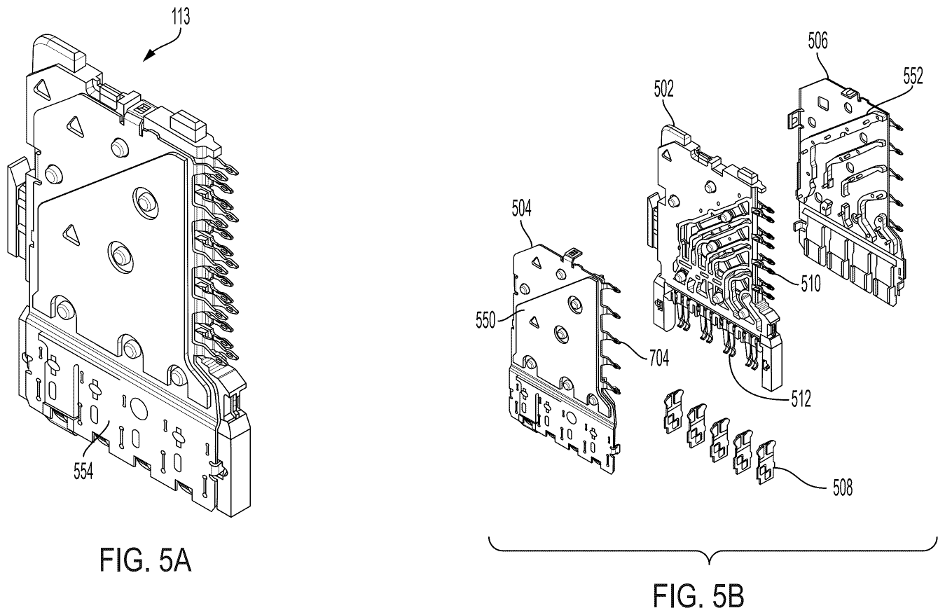

Each of the conductors may include a structure for completing a connection to the PCB. Such a structure may be at a second end of the conductor and joined through an intermediate portion of the conductor. At the second end, electrical connections are made between the conductors and respective conductive structures of the PCB that carry signals or are connected to ground when the daughter card connector 110 is mounted to the PCB. In some embodiments, the conductors of the daughter card connector 110 may include signal conductors and ground conductors. The connections to the PCB may be made differently for the signal and ground conductors. Optionally, daughter card connector 110 may include shields, which are also included in the illustrated embodiment (e.g. shields 504 and 506, FIG. 5B).

The signal conductors may be designed to connect to corresponding conductive structures of a PCB when the daughter card connector 110 is mounted to the PCB. For example, the signal conductors may have contact tails that are press fit, “eye of the needle,” contacts that are designed to be pressed into vias in the PCB. The vias may be electrically connected to signal traces within the PCB.

The conductors of the daughter card connector 110 may include ground conductors designed to electrically connect to corresponding conductive structures of a PCB when the daughter card connector 110 is mounted to the PCB. For example, the ground conductors may make an electrical connection with ground planes of the PCB when the daughter card connector 110 is mounted to the PCB. In the example illustrated, the ground conductors are connected to ground structures of the PCB though one or more conductive contact members. Each conductive contact member may connect multiple ground conductors to a ground structure of the PCB.

In some embodiments, the daughter card connector 110 may include one or more conductive contact members designed to electrically connect to a ground structure of PCB. Each conductive contact member may make connection to one or more locations on the PCB. The ground conductors may be connected to the conductive contact members such that the ground conductors make an electrical connection to the ground structure of the PCB through the conductive contact members. For example, the conductive contact members may be conductive plates with compliant contacts cut in them, and the ground conductors may connect to the conductive plates. In this example, when the daughter card connector 110 is connected to a PCB, the compliant contacts of the conductive plates may contact a ground structure of the PCB to create an electrical connection between the ground structure of the PCB and the ground conductors of the daughter card assembly 110 that are coupled to the plate.

The ground conductors in the lead assembly may be directly connected to a ground structure of a PCB. For example, the ground conductors may contact the ground structure with the PCB. Alternatively, the ground conductors may indirectly connect to the ground structure of the PCB. For example, the ground conductors may contact a conductive gasket that provides a connection to the ground structure of the PCB.

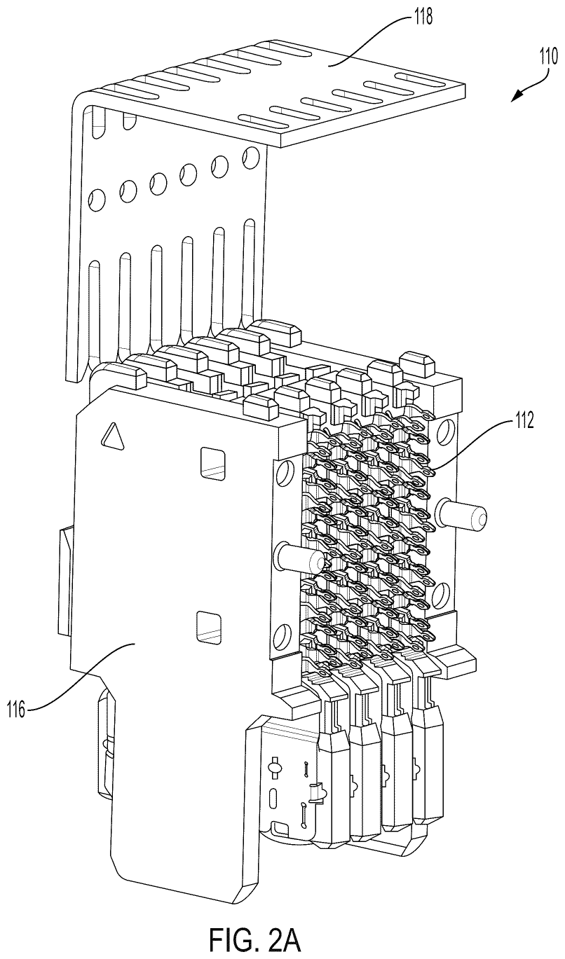

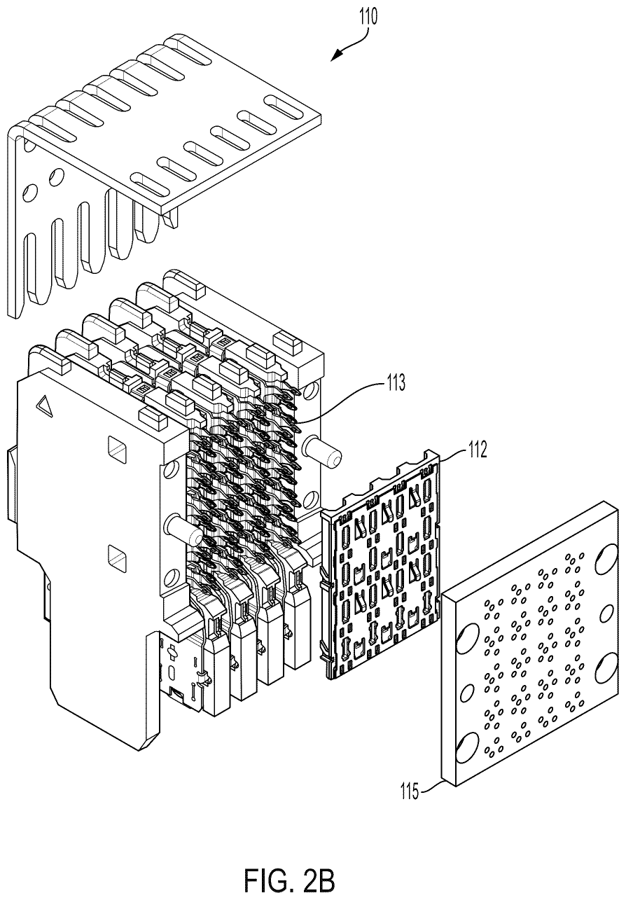

FIGS. 2A and 2B show components of the daughter card connector 110 of the interconnection system 100 of FIGS. 1A-1B, according to some embodiments. Such a connector may be mounted to a daughter PCB 115. As shown in FIGS. 2A and 2B, the daughter card connector 110 may include an organizer assembly 112, one or more wafers 113, guide modules 116, and a stiffener 118.

Stiffener 118 may be formed from a blank, stamped from a sheet of metal, and bent into the configuration illustrated. In other examples, stiffener 118 may be an insulative material. For example, the stiffener 118 may be insulative plastic material. Stiffener 118 includes features that engage complementary features of wafers 113 and guide modules 116, holding multiple wafers 113 and guide modules 116 as a module, configured to mate with a backplane connector 120. In this example, four wafers and two guidance modules are shown mating to one backplane connector 120. In other examples, there may be more or fewer wafers per connector.

Alternatively or additionally, backplane connector 120 may be one module of a backplane connector and a larger backplane connector may be formed by aligning multiple such modules. In that example, the structure illustrated in FIGS. 2A and 2B may be one module of a daughter card connector, which may be formed from multiple such modules, or more components may be mounted stiffener 118 to form a longer daughter card connector of a size that mates with a longer backplane connector. In the illustrated example, each module includes four wafers 113 with one organizer assembly 112 providing electrical and mechanical connections for the wafers of the module.

The guide module 116 may bracket wafers 113. In some embodiments the guide module 116 may be an insulative material. For example, the guide module 116 may be insulative plastic material. In some embodiments, the guide module 116 may be shaped to engage complementary features of a backplane connector 120.

Each of the wafers 113 may comprise of multiple conductors (e.g., signal conductors, ground conductors). In some embodiments, the conductors may be organized into columns comprising of a set of signal conductors and ground conductors. In the example illustrated, each wafer includes one column of both signal and ground conductors. In this example, each of the wafers includes signal conductors for carrying multiple signals through the connector. Adjacent signal conductors in the column are separated by one or more ground conductors. In the example illustrated, the connector is configured to carry signals on differential pairs of signal conductors, such that adjacent pairs of signals conductors are separated by a ground conductor. In this example, to provide symmetry for all pairs, a ground conductor is positioned within the column on both sides of each pair.

In the example illustrated, the signal and ground conductors within the wafer are coupled to the PCB 115 in different ways. The signal conductors may have ends (e.g., tails) at a mounting interface of the daughter card connector 110 with the daughter PCB 115. The tails may extend through organizer assembly 112 and directly connect to PCB 115. In this example, the tails are configured as pressfits such that they may be coupled to signal traces within PCB 115 when the tails are pressed into via holes connected to the signal traces. In contrast, the ground conductors may be coupled to the PCB via a conductive contact member in organizer assembly 112.

Accordingly, organizer assembly 112 may facilitate electrical connection of the wafers 113 with the daughter PCB 115 at a mounting interface with the daughter PCB 115. In some embodiments, the organizer assembly 112 may include a conductive plate. The ground conductors of the wafer 113 may contact the conductive plate and make electrical contact with the conductive plate. The conductive plate may include structures that makes electrical contact with the PCB 115 when daughter card connector 110 is mounted to the PCB 115. The structures may extend from the conductive plate such that they contact corresponding ground structure(s) of the PCB 115. In some embodiments, a structure may be a spring finger that compresses against a corresponding ground structure on a surface of the PCB 115 when daughter card connector 110 is mounted to the PCB 115. For example, the spring fingers may compress against corresponding ground pads on the PCB 115, thus creating electrical contact. The ground conductors of the wafers 113 may thus make electrical contact with the ground structures of the PCB 115 through the spring fingers. The spring fingers may provide sufficient force when compressed against ground structure(s) of the PCB 115 to provide reliable electrical contact with the ground structure(s).

Organizer assembly 112 may also serve other functions. It may, for example support and/or align press fit tails extending from daughter card connector 110. The pressfit tails, for example, may be at an end of the signal conductors within each of the wafers 113 and/or extending from shields attached to or disposed between the wafers. Alternatively or additionally, organizer assembly 112 may provide conductive paths between grounded structures of daughter card connector 110.

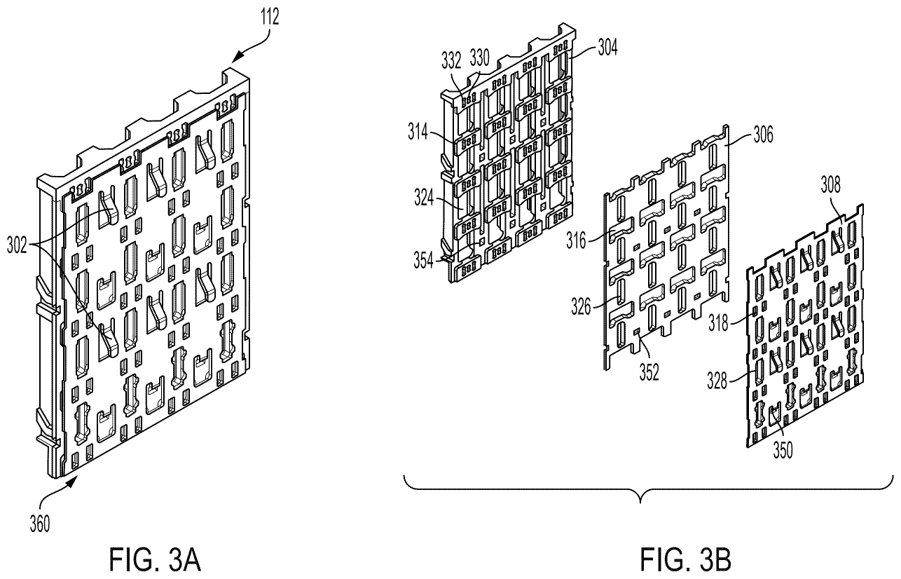

FIG. 3A is a perspective view of the organizer assembly 112 of FIG. 2B, according to some embodiments. FIG. 3B shows components of the organizer assembly 112, according to some embodiments. In this example, the components of the organizer assembly 112 include a lossy member 304, a plastic layer 306, and a plate 308.

In the example of FIGS. 3A-3B, the organizer assembly 112 includes components of three different types of materials that have different electrical and mechanical properties. Those components include a component that are conductive, insulative and lossy.

The conductive component may be a plate 308, which may be metal such that it is sufficiently springy to form contacts 302 integral with the plate 308. Tabs 350 may similarly be formed integral with plate 308, such as in a stamping and forming operation. In this example, contacts 302 are fingers that extend from the plate 308. The fingers may compress against corresponding ground structure(s) of a PCB when daughter card connector 110 is mounted to the PCB 115. For example, a surface of the PCB 115 may include a conductive pad connected to other ground structures of the PCB 115. The contacts 302 may compress against the body of the PCB 115 and generate a spring force that creates electrical contact with the ground structure of the PCB 115. The electrical contact with the ground structure of the PCB 115 may create an electrical connection between the ground structure of the PCB 115 and any of the conductive structures of the daughter card connector 110 that are coupled to plate 308.

In some embodiments, the organizer assembly 112 may include an insulative component. In the example of FIGS. 3A-3B, the insulative component is a plastic layer 306 between the lossy member 304 and the conductive plate 308. Additionally or alternatively, the insulative component may be made of material such as nylon, liquid crystal polymer (LCP), polyphenylene sulfide (PPS), polypropylene (PP), or other suitable insulative material.

In the example of FIGS. 3A-3B, the organizer assembly 112 includes a lossy member 304. Lossy member may facilitate connection between conductive structures of the daughter card connector 110 and plate 308. Lossy member 304 may be molded from plastic that is filled with or coated with conductive material. In this example, lossy member 304 is molded with islands 314. Each of the islands 314 extends into and may extend through an opening 316 of plastic layer 306 such that the lossy island 304 is exposed for connection to plate 308. In this example, stubs of ground conductors of the wafers 113 extend into openings 330 of lossy member 304, where they are coupled to lossy member 304, either through being in close proximity to lossy member 304 or through contact. For example, the stubs may form an interference fit with the openings in lossy member 304. Pressfit tails extending from other ground structures may be coupled to lossy member 304. In the example illustrated, pressfit tails of shields may extend through openings 332 in lossy member 304. Those tails may also be coupled to lossy member 304 as a result of close proximity and/or contact.

In the illustrated example, the lossy member 304 may be designed to reduce resonance between ground structures of daughtercard connector 110, particularly at the mounting interface between the daughter assembly 110 and a PCB. In the illustrated example, the lossy member 304 is between the conductive plate 308 and the wafers 113.

The organizer assembly 112 includes openings that allow mounting ends of signal conductors of the daughter card connector 110 to pass through the organizer assembly 112 (e.g., for connection with corresponding structures on a PCB). The lossy member 304 may surround the mounting ends of the signal conductors but may be sufficiently separated from the lossy member 304 that there is little or no appreciable coupling between the signal conductors and the lossy member 304. In this example, lossy member 304 includes openings 324 that align with openings 326 in plastic layer 306 and openings 328 in plate 308, forming a channel through which tails of signal conductors may pass through the organizer assembly 112. Openings 328 in plate 308 may be sufficiently large that tails of signal conductors passing through such a channel have little or no electrical coupling to plate 308.

In this example, the signal conductors in each wafer are organized in pairs. One pair may extend through each of the channels formed by the alignment of openings 324, 326 and 328. In this example, these openings are elongated in a column direction 360, which enables a pair of signal conductors, spaced apart in the column direction to fit through each of the channels. Lossy member 304 and plate 308 may be sufficiently set back from the signal conductors passing through those channels that there is no appreciable coupling between the signal conductors and the lossy member and/or the plate 308. As plastic layer 306 is formed of an insulator, plastic layer 306 may contact the tails of signal conductors passing through organizer assembly 112. Such contact may be possible or desirable in some instances to provide mechanical support and/or to provide dielectric material around the signal conductors that provides an impedance matching the impedance inside the body of each of the wafers 113.

Plate 308 may be stamped and formed from metal. Plastic layer 306 may be molded from a thermoplastic material, which may include insulating fillers, such as glass fibers. In the illustrated example, lossy member 304 is also molded from a thermoplastic material, but with a conductive filler at levels to provide lossy conduction. Lossy member 304 and plastic layer 306 may be molded separately and then attached to one another.

Alternatively, lossy member 304 and plastic layer 306 may be formed through a multi-shot molding operation. Lossy member, for example, may be molded and then plastic layer 306 may be molded over it. In this example, plate 308 may then be attached to the combined structure. For example, tabs 350 may be pressed into openings 352 in plastic layer 306 to attach plate 308 to plastic layer 306. In this example, tabs 350 extend through openings 352 into openings 354. Tabs 350 may form an interference fit with openings 354 such that tabs 350 are both mechanically and electrically connected to lossy member 304. Though, electrical coupling to lossy member 304 may result without mechanical contact, such as by capacitive coupling across a short distance.

As yet another alternative, organizer assembly 112 may be formed through an insert molding process. Plastic layer 306, for example, may be molded over plate 308. Lossy member 304 may then be molded over plastic layer 306. In this example, the lossy islands 314 may be molded such that they are in contact with, and may be adhered to, plate 308. Alternatively or additionally, in place of holes 354, lossy member 304 may include pillars that extend through holes 352 in plastic layer 306. The pillars of lossy material may encapsulate tabs 350 or otherwise interlock with plate 308.

Lossy member may be made from a lossy material. Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz, 25 GHz to 30 GHz, or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

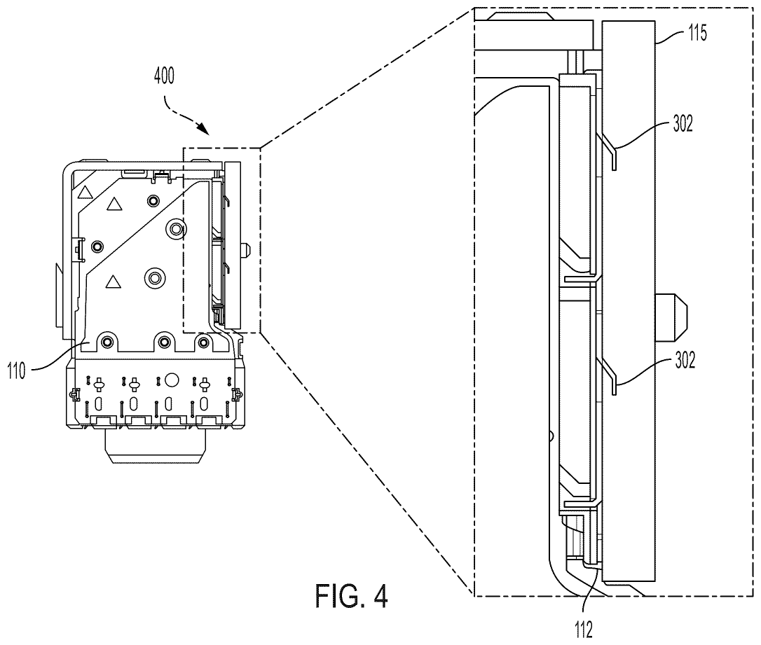

FIG. 4 is a side view daughter card connector 110 with a guide model 116 removed to expose a side of a wafer 113. FIG. 4 illustrates a mounting interface 400 of the daughter card connector 110 mounted to PCB 115, according to some embodiments. The mounting interface 400 includes electrical contacts 302 of the conductive plate 308 that make electrical contact with a corresponding ground structure of the PCB 115. PCB may include a ground pad on a surface aligned with contacts 302 or may include a ground plane on its surface, with at least the portions aligned with contacts 302 exposed. For example, a solder mask may be removed such that contacts 302 engage the conductive pad.

The contacts 302 may be compressed against the PCB 115. The spring force resulting from the compression results in electrical contact between the electrical contacts 302 and the ground structure of the PCB 115. The contacts 302 may create an electrical connection between the ground structure of the PCB 115 and a conductive member of the daughter assembly, which in turn connects to ground conductors of the daughter assembly. In FIG. 4, compression is indicated by showing contacts 302 in an uncompressed state such that they are shown overlapping with PCB 115. In operation, as daughter card connection 110 is pressed against PCB 115, contacts 302 will flex such that they do not extend past the surface of PCB 115.

Ground conductors of the wafers 113 may not be directly connected to a ground structure of the PCB 115 without being directly connected to the PCB 115. For example, the daughter card connector 110 may include a conducting gasket that contacts the PCB 115 as well as the ground conductors. Alternatively, the ground conductors of the wafers 113 may be directly connected to the ground structure of the PCB 115.

FIG. 5A is a perspective view of a wafer 113 of daughter card connector 110 FIGS. 1A-1B, according to some embodiments. FIG. 5B further shows components of the wafer 113 of FIG. 5A exploded, according to some embodiments. In the illustrated example, the wafer 113 includes a column of conductors including signal and ground conductors. In some embodiments, signal conductors or pairs of signal conductors may be equally spaced in a column. In some embodiments, a spacing between two adjacent signal conductors may be less than 2.0 mm, 1.9 mm, 1.8 mm, 1.7 mm, 1.6 mm, or 1.5 mm. In some embodiments, a center-to-center spacing of pairs of signal conductors along the column may be less than 3.0 mm, 2.5 mm, 2.3 mm, 2.1 mm, or 2.0 mm. In some embodiments, the spacing of signal conductors may be approximately the same in all wafers of the wafer 113.

In some embodiments, there may be 2 to 12 signal conductor pairs along a column. In some embodiments, a linear density of signal conductors along a connector may be between 10 and 60 pairs of signal conductors per cm. In some embodiments, the linear density may be substantially uniform along the length of the connector.

In some embodiments, each signal conductor or pair of signal conductors in a column may be bounded by ground conductors. For example, the signal conductors may comprise pairs of differential signal conductors in a column, where each pair of differential signal conductors is bounded by ground conductors. In some embodiments, mounting ends of ground conductors of a wafer may be shaped different than mounting ends signal conductors. The mounting ends of the signal conductors may be shaped for connection to corresponding structures of the PCB 115 while the mounting ends of the ground conductors may be shaped for connection to a conductive contact member of the daughter card assembly 110. For example, the mounting ends of the signal conductors may be tails, such as pressfit tails, configured for connection to vias of the PCB 115 while the mounting ends of the ground conductors may be stubs that are coupled to a conductive contact member, sch as plate 308.

In some embodiments, ground conductors of a wafer may terminate at a conductive contact member. Mounting ends of the ground conductors may be connected to the conductive contact member, such as through the use of lossy material or other intermediate structure. In some embodiments, the conductive contact member may include openings that receive mounting ends of the ground conductors. For example, the openings may be designed to receive stubbed ends of the ground conductors to form an interference fit. In some embodiments, the conductive contact member may include one or more conductive plates that are electrically connected to the ground conductors. The conductive contact member may be made of any suitable conductive material. For example, the conductive contact member may be made of steel, copper, aluminum, phosphor-bronze, beryllium copper, a copper alloy, or another material of suitable conductivity and springiness.

The conductors of a wafer may be made of any suitable conductive material. For example, the conductors may be made of metal or another material with suitable conductivity. Example materials include phosphor-bronze, beryllium copper, and other copper alloys. For example, signal conductors may be formed by stamping and forming a sheet of metal. In some embodiments, one stamping may produce a lead frame containing all or a part of column of conductors. Such an operation may result in ground conductors being in line with signal conductors in the column. Such an operation enables precise control over the width of signal conductors and precise positioning of the edges of the conductors relative to each other. Such a configuration enables precise control over the impedance of the signal conductors, which promotes signal integrity within the connector.

The signal conductors may be stamped with tails for attachment to a PCB. In contrast, ground conductors may be stamped with stubbed ends (e.g., to be connected to a conductive contact member within organizer assembly 112).

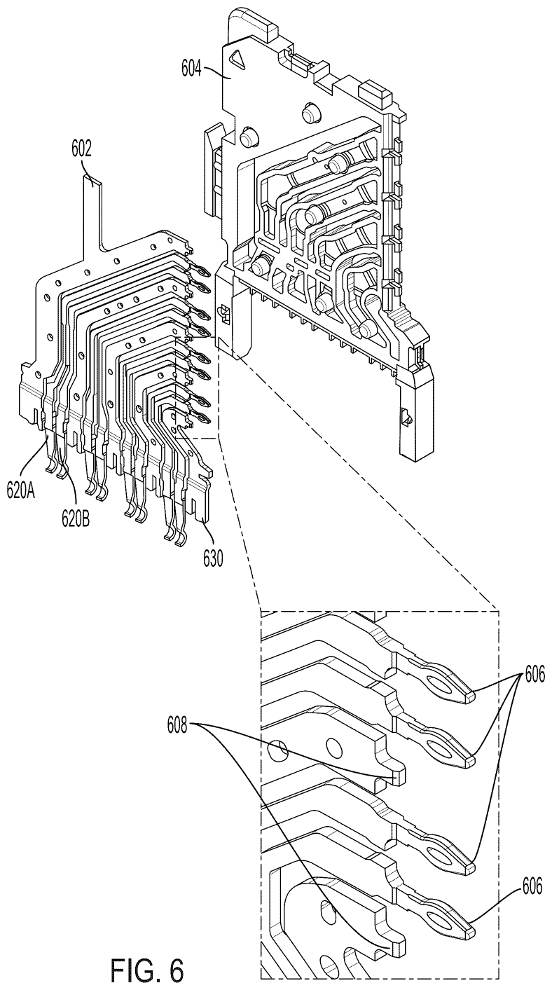

In the example of FIGS. 5A-5B, the wafer 113 includes lead frame assembly 502, a left shield 504, a right shield 506, and a cross shield assembly 508. The lead frame assembly 502 includes a column of conductors of the wafer 113 with an insulative housing to hold the conductors in position. In some examples, the leads in a lead frame may be pressed into the insulative housing. In the illustrated example, however, the housing of the lead frame assembly 502 may be formed around the conductors. For example, the housing may be formed by an insert molding process around the conductors such that the housing is insert molded plastic 604 (FIG. 6).

The mounting ends 510 of the conductors extend from the housing of the lead frame assembly. The conductors of the lead frame assembly 502 also include mating portions 512 for mating of the wafer 113 with a corresponding portion of a backplane assembly (e.g., as shown in FIG. 1B). In this example, the mating portions 512 of the signal and ground conductors have a different configuration. When the daughter assembly 110 is mated with the backplane assembly 112, the mating portions 512 will press against respective mating contact portions of the backplane assembly 112. The mating portions of signal conductors, such as pair of signal conductors 620A, 620B (FIG. 6) are shaped as compliant beams. In some embodiments, the mating contact portions of the backplane assembly 112 may be blades, pads, or other flat surfaces. When the daughter assembly 110 is mated with the backplane assembly 112, the mating portions 512 may contact the mating portions of the backplane assembly 112 to form an electrical connection.

The mating portions of the ground conductors, of which ground conductor 630 is numbered, are made of two pieces. The ground conductor 630, for example, may include a slot into which is inserted a cross shield assembly 508. The dimensions of the slot may be smaller than the thickness of the cross shield assembly 508 such that a secure interference fit is formed. In other examples, however, the cross shield assembly 508 may be formed including a portion of the same sheet of metal stamped to form the lead frame 602 (FIG. 6), twisted out of the plane of the lead frame 602.

FIG. 6 is an exploded view of a lead frame assembly 502 with lead frame 602 shown separated from the insulative housing. In this example, ground conductors are wider than the signal conductors, with a ground conductor on each side of each pair of signal conductors. The signal conductors of each pair are shown coupled edge-to edge (rather than broadside to broadside, which may be used in alternative embodiments). The ground conductors are coupled edge-to-edge to adjacent signal pairs.

In the example of FIG. 6, the lead frame 602 resides in insert molded plastic 602. The insert molded plastic 602 includes channels. The channels may be aligned with ground conductors in the lead assembly and may receive projects that are part of shields 504 and 506 that may be attached to the lead frame assembly 502. For example, each of the shield may include an overmold of lossy material forming projections 552 that may fit within the channels. Alternatively or additionally, channels in the insulative housing may align with signal conductors to reduce the effective dielectric constant of the housing material adjacent the signal conductors, which may improve signal integrity, such as by reducing dielectric loss and/or setting the impedance to a desired level.

In the example of FIG. 6, the signal conductors are grouped into pairs along each column. The mounting ends of the signal conductors are tails 606 configured for mounting to a PCB. The signal conductors are positioned such that, when the daughter assembly 110 is mounted to a PCB, the mounting ends connect to corresponding vias of the PCB. Pairs of signal conductor tails 606 are positioned between ground stubs 608 of ground conductors of the lead frame 602. In the illustrated example, the ground stubs 608 are of a different shape than the signal tails 606. In some embodiments, the ground stubs 608 may require less space than tails configured for attachment to a PCB, and thus allow for increased density of signal conductors in the column of the lead frame 602. Here, tails 606 are illustrated as press fits, which are widened near a distal end to enable compliance upon insertion in a via. However, a similar disparity of width along the column direction between the ends of the signal and ground conductors may also exist for other mounting technologies, such as BGA, which may have pads or other structures on the signal conductors for receiving a solder ball, which may be omitted with the approach of making connections from the ground conductors in a wafer to a PCB through an organizer assembly.

Instead of or in addition to ground conductors in line with each column of signal conductors, a connector may include shields, which may be generally planar conductive structures positioned between columns. One or more shields may be integrated into each wafer 113. In the example embodiment, one or more shields are attached to each lead frame assembly 502 in a wafer 113. Returning to FIGS. 5A-5B, each of the left and right shields 504,506 may include a conductive plate connected to ground when the daughter card connector 110 is attached to a PCB.

For grounding, each plate may include contact tails 704 that extend from the plate for connection to a ground structure of a PCB to which the connector is mounted. The contact tails 704 for the shields may be configured for the same type of attachment as the tails of the signal conductors. In this example, the tails for the shieled plates are configured as pressfits. The pressfits may be the same size as the pressfits for the signal contacts, but in some examples may be bigger or smaller.

In the example of FIGS. 5A-5B, the contact tails 704 for each shield are positioned in a column that is parallel to the column of conductors of the lead frame assembly 502. In some embodiments, the contact tails may be in the same plane as the body of the ground plate from which the contact tails extend. However, as can be seen in the example of FIG. 5A, the tails 704 of the shields jog inwards towards a centerline of the wafer 113. The shield tails in this example are positioned to pass through openings of lossy islands 314, openings 316 and corresponding openings 318 in plate 308. The shield tails may be coupled, either through contact or proximity, to lossy member 304 and/or plate 308.

For enabling ground current to flow through each shield, the shields may include a contact surface 554. The contact surface 554 may be positioned to press against a torsional contact 556 (FIG. 1B) in a shield in a mating connector. Additionally, in the illustrated example, each of the shields 504 and 506 is connected to one or more cross shield assemblies 508 engages shields 504 and 506 at opposite edges. Each cross shield assembly, for example, may include tabs inserted into a slot in one of the shields 504 or 506. In the example illustrated, each of the cross shield assemblies may include compliant beams that may mate with blades or plates within a mating connector.

Optionally, each shield 504 and 506 may include a lossy overmold 550. The lossy overmold may have a generally planar portion on an exterior surface of the shield (i.e. facing away from the centerline of wafer 113). The overmold may extend through slots (not shown) in the shield to form projections 552 from an inner surface of the shield. The projections, for example, may fit into channels in plastic 604 where they may couple, cither through direct contact or proximity, to the ground conductors of the lead assembly.

In the example of wafer 113, cross shield assemblies 508 are positioned between pairs of differential signal conductors of the lead frame assembly 502. In the illustrated example, the cross shields have planar surfaces that are perpendicular to the column direction of the conductors of the lead frame assembly 502. The cross shields thus separate pairs of signal conductor mating portions in the column direction. Each pair of signal conductor mating portions may be positioned between two cross shields.

In some embodiments, the cross shields of the cross shield assembly 508 may connect to conductive structures within the wafer 113 that are connected to ground. For example, the cross shields may connect to ground conductors of the lead frame assembly 502. In addition to providing shielding, the cross shields may form the mating portion of the ground conductors. The upper end of the cross shields may be shaped to make a connection with the ends of the ground conductors. Additionally or alternatively, the ground shields may be electrically connected to conductive ground plates of the left and right shields 504, 506. For example, the cross shields may be inserted into slots of the shields 504, 506 to form an electrical connection to ground structure of the wafer 113.

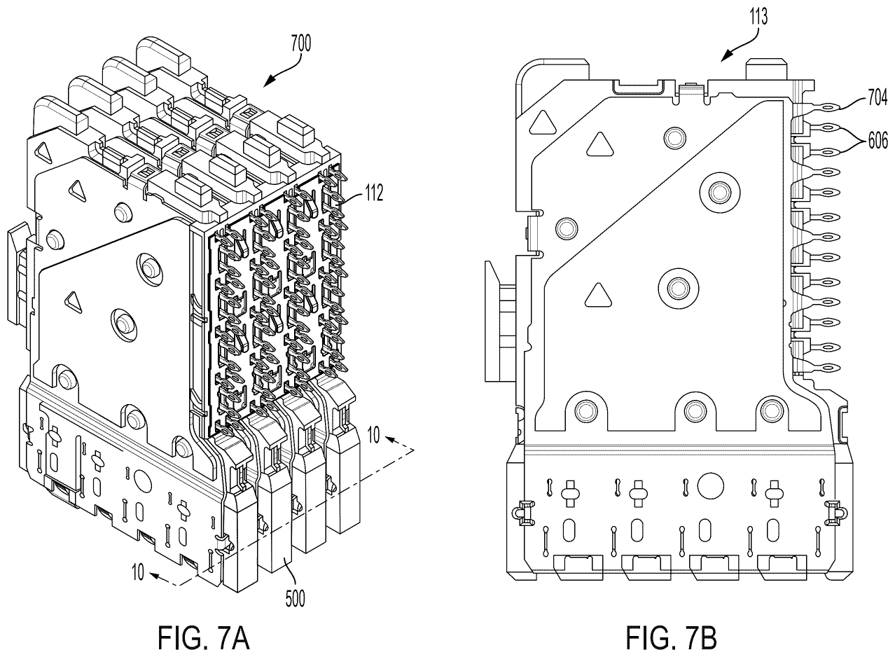

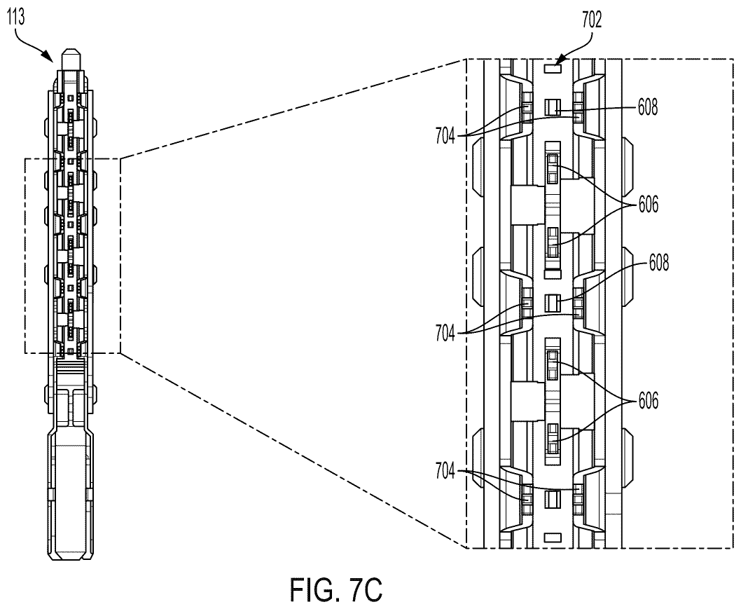

FIGS. 7A-7B show perspective and side views of four wafers of a daughter card connector 110 connected to an organizer assembly 112, forming a connector module 700, according to some embodiments. As illustrated in FIGS. 7A-7B, the conductor columns of the wafers are separated by the shields of the respective wafers. In this example, the tails 704 of the shields are offset, in a direction perpendicular to the column direction of each wafer, from the tails 606 of the signal conductors of the column. The tails 704 of the shields are offset in the column direction from the tails 606 of the signal conductors of the column. In this example, the shields 504 and 506 on each side of lead frame assembly 502 have symmetrically positioned tails 704, a pair of tails separates, in the column direction, each pair of tails 606.

FIG. 7C is a planar view of a mounting interface of a wafer 113 in the connector module 700 of FIGS. 7A-7B, according to some embodiments. As shown in FIG. 7C, the wafer 113 includes a column 702 of conductors including ground and signal conductors. The illustrated example shows a mounting surface of the mounting portions of the conductors which include tails 606 of the signal conductors and stubs 608 of the ground conductors. Each pair of signal conductors is bounded on two sides in a direction of the column 702 by ground stubs. Shield tails 704 extending from the shields are aligned with the ground stubs 608. Each of the ground stubs 608 is bounded by two shield tails in a direction perpendicular to the direction of the column 702.

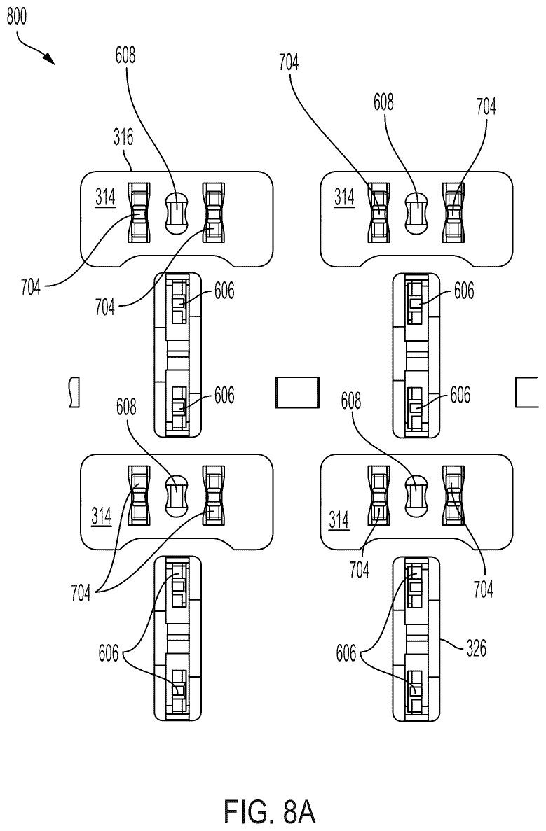

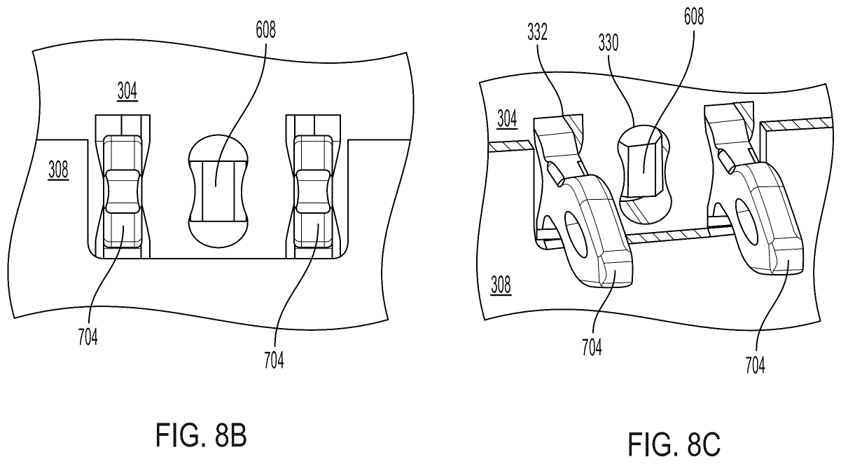

FIG. 8A is a plan view of a portion of a mounting interface 800 of the daughter assembly 110 of FIGS. 1A-1B without plate 308 in place, according to some embodiments. The portion illustrated includes tails 606 of two pairs of signal conductors in each of two adjacent columns. In the illustrated example, the ground stubs 608 of the ground conductors are coupled to lossy islands 314. In this example, coupling is through direct contact as the stubs 608 extend into a hole in respective lossy islands. The side walls of the holes are shaped to make contact with the stub 608 when inserted.

The shield tails 704 may also pass through lossy islands 314. The shield tails may be coupled to the lossy islands. Such coupling may be through proximity or contact.

Pairs of signal conductor tails 606 in each column are bounded on two sides in the column direction by the conductive structure formed by the combination of the lossy and conductive structures for lossy islands 314, tails 704 and tubs 608. The inventors theorize that this configuration provides substantial benefit in signal integrity.

FIGS. 8B-8C provide enlarged views of one of the ground stubs 608 and tails 704 from a pair of shields with plate 308 shown partially cut away. As shown in FIGS. 8B and 8C, the ground stub 608 is embedded in an opening 330 of the lossy member 304, which in turn is coupled to plate 308, as described above. As a result, the ground stub 608 is coupled to the conductive plate 308 through the lossy member 304. Shield tails 704 that bound the ground stub 608 are shown passing through openings 332 of lossy member 304 and passing through the conductive plate 308.

In the example of FIG. 8C, the walls of opening 330 bulge inwards to create a passage through opening 330 that is narrower than the width of ground stub 608. Such a configuration is an example of a mechanism to create direct contact between ground stub 608 and lossy member 304. Similar bulging walls are not show for openings 332, but sidewalls of openings 332 optionally may bulge inwards to make contact with shield tails 704.

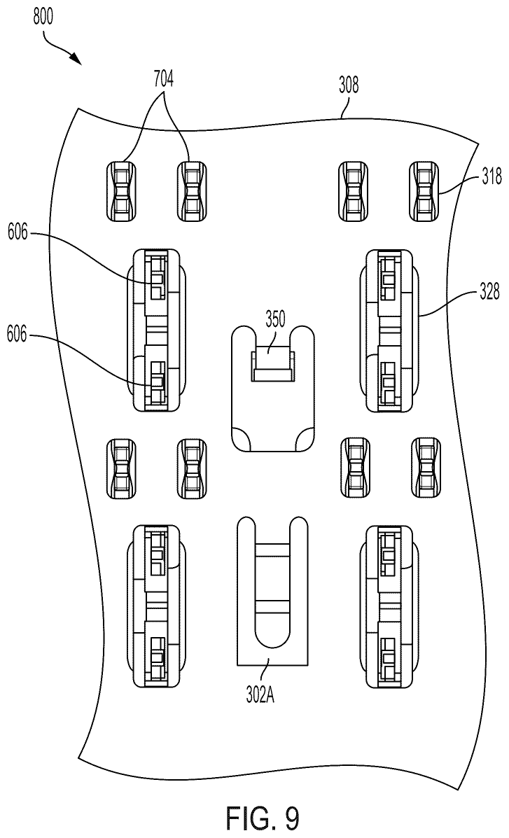

FIG. 9 is a plan view of a portion of the mounting interface 800 of FIG. 8A with plate 308 in place. As shown in FIG. 9, the illustrated portion of the mounting interface 800 includes the electrical contacts 302 of the organizer assembly 112 described herein with reference to FIGS. 3A-3B. The tails 704 of the shields and tails 606 of the signal conductors are visible because they pass through plate 308. The ground stubs 608 are no longer visible because they are covered by the plate 308 of the organizer assembly 112 in the illustrated example. In other implementations, however, the ground stubs 608 could pass through plate 308 or enter a opening in plate 308 without passing through. Having ground stubs 608 enter or pass through a hole in plate 308 would enable direct contact between stubs 608 and plate 308, such as might result from an interference fit of the stubs 608 in the holes in plate 308. Such direction connection may be used instead of or in addition to indirect connection through lossy member 304.

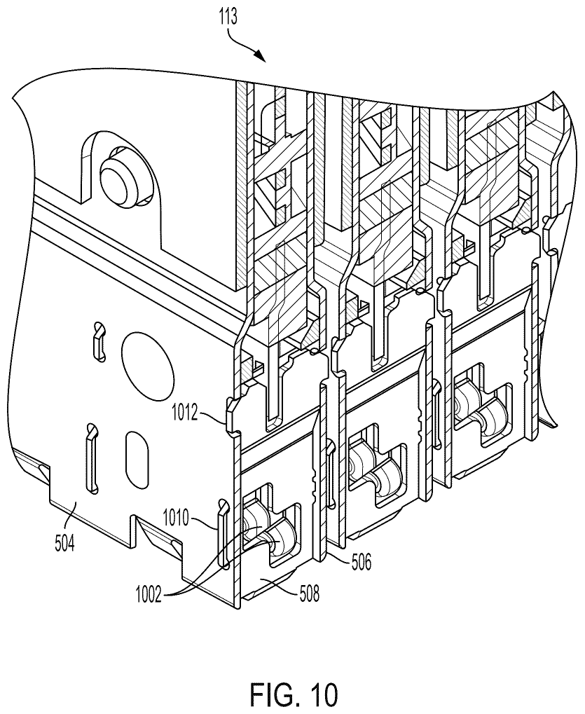

FIG. 10 is across sectional view of a plurality of wafers aligned side-by-side, as in FIG. 7A. FIG. 10 is a sectional view along line 10-10 in FIG. 7A. In this view, tabs 1010 and 1012 of cross shield assembly 508 are visible engaging with slots in shield 504. The cross shield assembly 508 is in a mating region of the electrical connector assembly and bounds a mating portion of a signal conductor of a lead frame in the wafer 113. In the example of FIG. 10, cross shields are positioned between pairs of differential signal conductors of a lead frame in the wafer 113. In some embodiments, the electrical connector assembly may include a sufficient number of cross shields such that each pair of differential signal conductors in the electrical connector assembly is between, and adjacent, two cross shields. As shown in FIG. 10, the cross shield assemblies 508 have a generally planer surface that is perpendicular to a column direction. In this configuration, the cross shield assemblies 508 bound one or more signal conductors in the column direction.

As shown in FIG. 10, the cross shield assembly 508 includes contacts 1002 configured to make contact with ground conductors of a mating connector that has a planar surface that is parallel to the generally planar surface of the cross shield assembly 508. The contacts 1002 may be configured to provide desirable contacting force. In some embodiments, the contacts 1002 may be formed as one or more beams that are bent of the plane of the body of the cross shield assembly 508. When a mating contact forces these beams towards the body of the cross shield assembly 508, a counter force, sufficient to provide electrical contact will be generated. In the example of FIG. 10, the contacts 1002 are formed as an assemblage of multiple beams, joined to the top of the body of the cross shield assembly 508.

In some embodiments, the cross shield assembly 508 may be made of components with different physical characteristics that are connected together. For example, the cross shield assembly 508 may include a first component made of a first material and a second component made of a second material. As a more specific example, the cross shield assembly 508 may include at least two components where a first component is thinner than a second component. Alternatively or additionally, one of the components may be formed of a more conductive material than another one of the components. The more conductive component may provide ground shielding for signal conductors. The less conductive component may have higher yield strength to provide reliable electrical contact of the contacts 1002 than can be provided by contacts formed by the more conductive material. The contacts 1002 may be formed of the material with the higher yield strength may provide a desired contact force against corresponding ground elements in a mating connector to ensure reliable electrical contact.

Components of the cross shield assembly 508 may be connected in a suitable way. The components may be mechanically connected to each other. In some embodiments, the components may be welded together. In some embodiments, the components may be joined together using a conductive adhesive material.

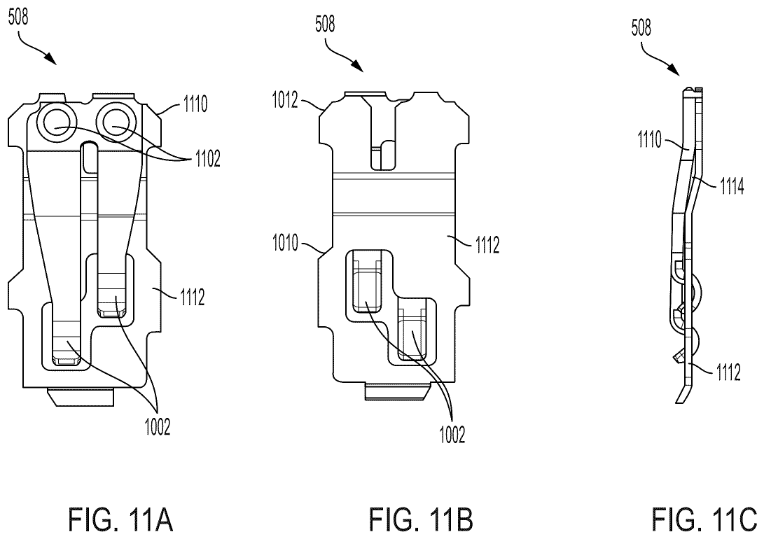

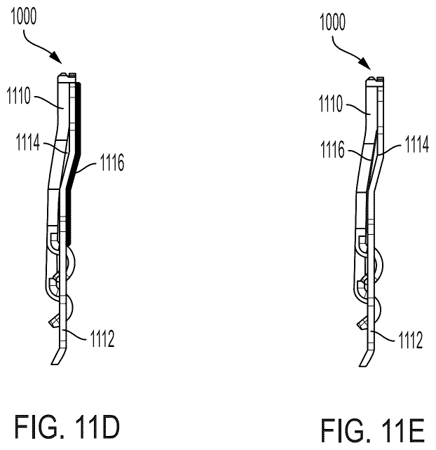

FIG. 11A is a plan view of a front surface of the cross shield assembly 508, according to some embodiments. In this example, the cross shield assembly 508 includes a first component of a first material that includes the contact portions 1002 and a second component of a second material that is connected to the first component. The first component is in this example shaped as beam member 1110 and the second component is configured as a plate 1112. In some embodiments, the first component may have a Young's modulus of approximately 18,900,000 psi. These components may be held together with welds 1102, which may be formed by laser welding. The second component may be welded to the first component at welds 1102.

The contact portions 1002 may be designed to generate a desired contact force when the electrical connector assembly is connected to a mating connector. In some embodiments, each of the contact portions 1002 may be configured to generate a contact pressure of at least 100 psi when the electrical connector assembly is connected to a mating connector. In the example of FIG. 11A, the contact portions 1002 include two contact portions. In some embodiments, the cross shield assembly 508 may include one contact portion, three contact portions, four contact portions, or any other suitable number of contact portions. The width and length of the beams may be selected to provide the desired contact force, within the constraints imposed by the miniaturized connector dimensions. To provide the necessary contact force, beam member 1110 may be stamped from a material that is springy, such as phosphor-bronze or other copper alloy or spring steel.

FIG. 11B is a plan view of a back surface of the cross shield assembly 508 showing the second component, according to some embodiments. In the illustrated example, the second component is a plate 1112. The plate 1112 is joined to the first component 1110 shown in FIG. 11A. The plate 1112 may be electrically and mechanically connected to the first component. In the example of FIG. 11B, the plate 1112 is welded to the first component shown in FIG. 11A.

FIG. 11C is a side view of the cross shield assembly 508 of FIGS. 11A-11B, according to some embodiments. The relative thicknesses of beam member 1110 and plate 1112 are visible. Beam member 1110 is thicker than plate 1112 such that the force generated by the beams of beam member 1110 is adequate for reliable mating. Plate 1112 is thinner, to reduce space while providing adequate shielding. Beam member 1110, for example, may have a thickness that is between about 1.5 and 3 times larger than the thickness of plate 1112.

As shown in FIG. 11C, there is a gap 1114 between the two connected components (i.e., beam member 1110 and the plate 1112) of the cross shield 1000. Though the gap is small, the inventors theorize that the gap may impact performance of the connector. The gap may resonate at frequencies within an operating range of the electrical connector, if designed for operation with high frequency signal. The resonance may degrade signal integrity, such as by increasing crosstalk and insertion loss at a resonant frequency within the operating range of the electrical connector. The gap, for example, may be between 50 and 70 micrometers, which may impact performance for connectors passing signals at frequencies between 10 to 100 gigahertz, for example. Thus, though the illustrated compound structure provides mechanical advantages in size and/or contact force, the inventors have recognized and appreciated that such a composite shielding structure could degrade connector performance.

In some embodiments, the cross shield assembly 508 may be electrically coupled with lossy material to mitigate the resonance. The lossy material may reduce the resonances excited within the operating range of the connector, such as by suppressing resonances entirely or shifting the resonant frequency outside the operating range of the connector. Accordingly the impacts on signal integrity associated with a gap between components of a composite ground structure may be ameliorated the positioning of lossy material where it impacts resonance in the gap The inventors have recognized and appreciated desirable positions for the lossy material and lossy material may be positioned at one or more of these locations.

The lossy material, for example, may be inside the gap 1114 between the first component 1110 and the plate 1112. The lossy material may be outside of the gap 1114. For example, the lossy material may be on a surface of the first component 1110 or the plate 1112 opposite the gap 1114. The lossy material may be on a surface of a housing enclosing the cross shield 1000. In some embodiments, the housing may comprise an insulative member and the lossy material may be attached to the insulative member. For example, the housing may have plastic filled with conductive particles, and the lossy material may be attached to the plastic. In some embodiments, lossy material may be in multiple locations described herein. For example, lossy material may be both inside the gap 1114 and outside of the gap 1114. In another example, lossy material may be on a surface of the first component 1110 and the plate 1112.

FIGS. 11D and 11E are side views of the cross shield assembly 508 of FIGS. 11A-11C with lossy material 1116 coated on surfaces of the components bounding the gap 1114. In FIG. 11D, the lossy material is coated on a surface the plate 1112, according to some embodiments. In the example of FIG. 11D, the lossy material 1116 is coated on the surface of the plate 1112 opposite the surface of the plate 1112 facing the gap 1114. The lossy material 1116 may reduce resonance of the gap 1114 and improve conductivity of the plate 1112.

Lossy material might also be positioned in the location shown in FIG. 11D by coating a lossy layer on a portion of an insulative housing of the connector that abuts a component of the composite grounded structure. For example, an insulative housing may abut plate 1112 in the region where lossy material 1116 is illustrated. The surface of that insulative housing abutting plate 1112 may be coated with a lossy material, such as by applying tape with embedded carbon particles or applying a conductive ink with a conductivity sufficiently low to introduce loss. Alternatively or additionally, the housing itself could be molded from a lossy material, such as described above for lossy member 304.

In FIG. 11E, lossy material 1116 is coated on a surface of beam member 1110. In this example, the lossy material 1116 is coated on a surface facing into the gap 1114, such that the lossy material is in the gap. In other examples, the lossy material could be coated on an opposite surface such that it is outside the gap. In both examples, the lossy material is electrically coupled to the components that bound the gap and is proximate the gap.

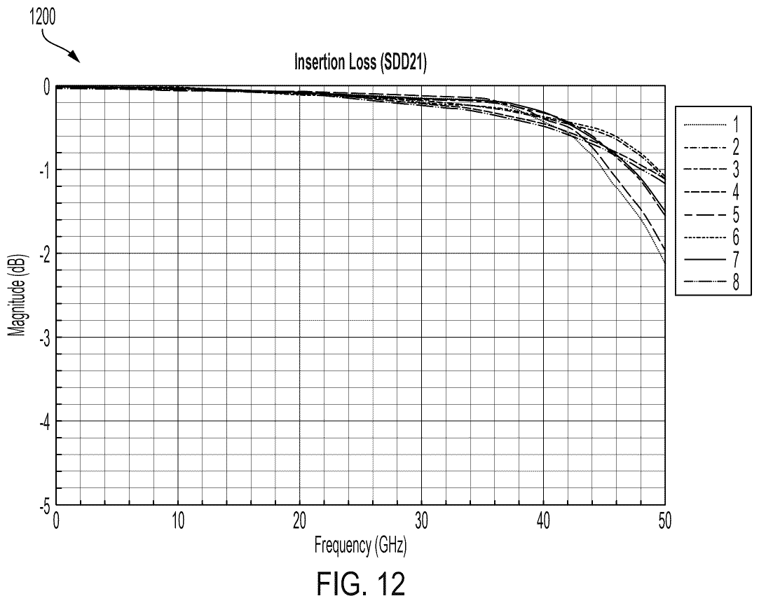

FIG. 12 is a graph of simulated loss of a signal through a connector with a cross shield including lossy material, constructed using techniques as described herein. The loss may result from crosstalk and/or insertion loss. In this example, FIG. 12 shows loss as a function of frequency for each of eight signal paths through a connector, such as might be formed by two wafers 113, each with four pairs for carrying differential signals. As shown in FIG. 12, the signal has less than a 1.5 dB loss for a frequency of 25 GHz, which may be the approximate frequency of the signal in an electrical connector of some embodiments. As illustrated in FIG. 12, the lossy material provides for low loss in an operational range of an electrical connector.

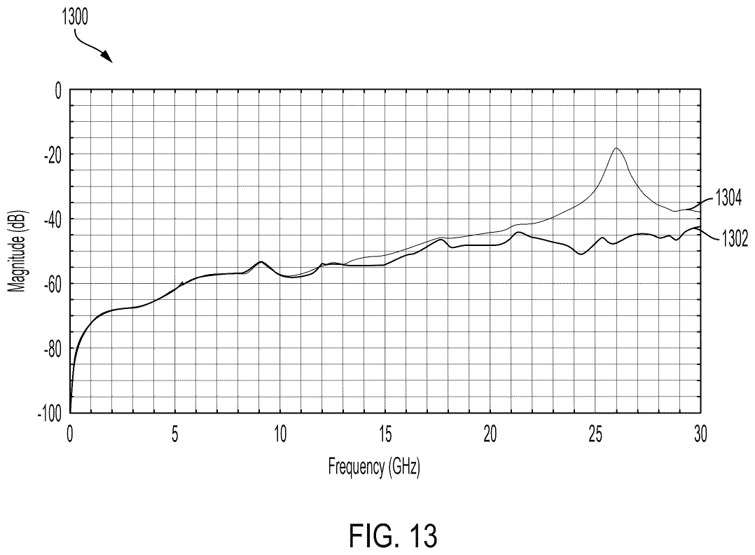

FIG. 13 is a graph 1300 illustrating simulated signal strengths through a first connector with a cross shield including lossy material constructed using techniques as described herein and a second connector without a cross shield including lossy material. The graph 1300 includes a signal strength 1302 of the first connector (i.e., with the cross shield including lossy material) and a signal strength 1304 of the second connector. As indicated by the signal strengths, the signal of the second connector has a distortion at a resonance frequency of approximately 26 GHz. In contrast, the signal of the first connector does not have such a distortion at the 26 GHz frequency due to the shielding including lossy material constructed using techniques described herein.

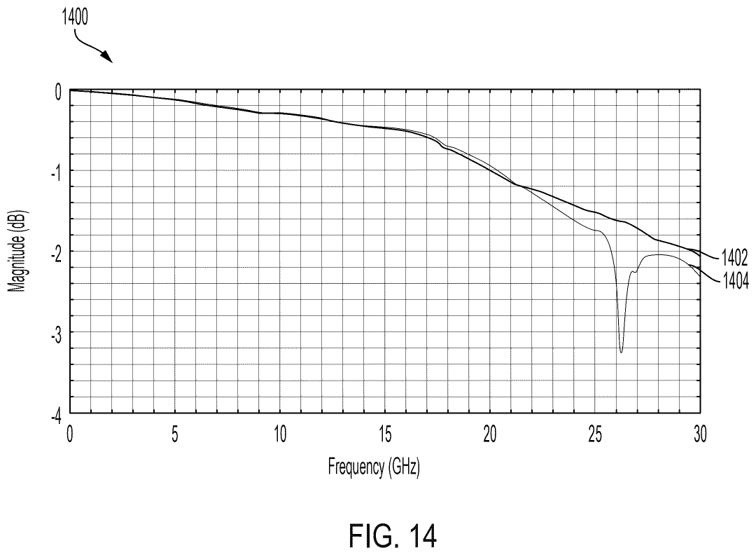

FIG. 14 is a graph 1400 illustrating simulated loss in signal strength through a first connector with a cross shield including lossy material constructed using techniques described herein and a second connector without a cross shield including lossy material. The graph 1400 includes a signal loss 1402 of the first connector and a signal loss 1404 of the second connector. As shown in FIG. 14, the signal loss 1402 of the first connector is less than that of the second connector at a resonance frequency of approximately 26 GHz. At this frequency, the signal loss 1402 of the first connector is approximately −1.6 dB while the signal loss 1404 of the second connector is approximately −3.2 dB.

The cross shield assembly 508 can include any suitable lossy material. In some embodiments, the lossy material may be carbon resistive ink. The carbon resistive ink may have a volume resistivity between 0.4 and 0.6 Ohm-centimeters. For example, the carbon resistive ink may have a volume resistivity of approximately 0.5 Ohms centimeter. In some embodiments, the lossy material may be a silicone-based conductive ink. For example, the silicon-based conductive ink may have a sheet resistance of approximately 0.05 Ohms/sq/mil. In some embodiments, the lossy material may be an electrically conductive adhesive transfer tape. For example, the electrically conductive adhesive transfer tape may have a resistance of less than 2.5 Ohms per square inch. In some embodiments, the lossy material may be plastic filled with conductive particles.

Introducing lossy material in the form of conductive ink may enable the lossy material to be introduced proximate structures that may tend to support resonances and degrade signal integrity. The ink may be thin enough to fit within a small space without degrading mechanical characteristics of the connector. The gap 1114 formed by a composite ground structure is an example of such a location. As the gap may be small, though present to support flexing of contacts 1002, filling it with a thick thermoplastic member might interfere with the connector operation. Accordingly, a thin coating, such as may be possible with conductive ink, may provide a suitable amount of loss.

As the goal of the conductive ink is to introduce loss, the conductive ink may be applied to a thickness that is less than conventionally used to make a conductive structure. The ink, for example, may be applied at a thickness of 20 microns or less, or at a thickness of 11 microns or less.

Although details of specific configurations of conductive elements, housings, and shield members are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described at least one embodiment, it is to be appreciated various alterations, modifications, and improvements may readily occur to those skilled in the art. Such alterations, modifications, and improvements are intended to be within the spirit and scope of the invention. Accordingly, the foregoing description and drawings are by way of example only.

Various changes may be made to the illustrative structures shown and described herein. As a specific example of a possible variation, ground conductors are described as engaging a conductive contact member with spring fingers that make contact to ground structures on a surface of a PCB. alternatively or additionally, the conductive contact member may have other types of contacts for engaging a ground structure on the PCB. The contacts may include surface mount solder contacts, including solder balls and pin in paste contacts. Alternatively or additionally, the contacts may include one or more pressfits. If the conductive contact member has fewer pressfit tails than there are ground conductors, without tails for attachment to a PCB, terminated to the conductive contact member, a space savings may nonetheless result. Space savings may also result if the conductive contact member has narrower pressfit contacts than the signal conductors or that would otherwise be used for ground conductors in a conventional connector.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

1. An electrical connector with a mounting interface for high-frequency and high-density connection to a printed circuit board (PCB), the electrical connector comprising:
a plurality of signal conductors, each of the plurality of signal conductors having an end at the mounting interface, wherein the end is configured for connection to the PCB;
a plurality of ground conductors, each of the plurality of ground conductors having an end at the mounting interface; and
a conductive contact member comprising a contact configured for connection to a ground structure of the PCB;
wherein:
the ends of the plurality of ground conductors are connected to the conductive contact member.

2. The electrical connector of claim 1, further comprising:
a lossy member connected to the conductive contact member;
wherein the ends of the plurality of ground conductors are connected to the lossy member.

3. The electrical connector of claim 2, wherein:
the lossy member comprises a plurality of islands; and
the plurality of islands are in contact with the conductive contact member.

4. The electrical connector of claim 3, wherein:
the plurality of islands have openings; and
the ends of the plurality of ground conductors are inserted into respective openings of the plurality of islands.

5. The electrical connector of claim 4, wherein the ends of the plurality of ground conductors are stubs.

6. The electrical connector of claim 1, wherein the ends of plurality of ground conductors are configured for engaging the conductive contact member.

7. The electrical connector of claim 1, wherein:
the conductive contact member comprises a metal sheet.

8. The electrical connector of claim 1, further comprising a plurality of ground structures comprising tails at the mounting interface, the tails of the plurality of ground structures passing through the conductive contact member.

9. The electrical connector of claim 8, wherein:
the conductive contact member comprises a conductive plate; and
the tails of the plurality of ground structures pass through the conductive plate.

10. The electrical connector of claim 8, wherein the plurality of ground structures are conductive shields for the plurality of signal conductors.

11. The electrical connector of claim 1, wherein:
the contact of the conductive contact member comprises a spring finger.

12. The electrical connector of claim 1, wherein the ends of the plurality of signal conductors pass through the conductive contact member and comprise pressfits.

13. The electrical connector of claim 1, wherein:
the plurality of signal conductors and the plurality ground conductors are disposed in a plurality of parallel columns; and
within each column of the plurality of columns, signal conductors of the plurality of signal conductors are disposed between and adjacent to ground conductors of the plurality of ground conductors.

14. The electrical connector of claim 1, wherein:
the plurality of signal conductors and the plurality of ground conductors are disposed in a plurality of columns with each column comprising pairs of conductive signal conductors with ground conductors of the plurality of ground conductors between the pairs of signal conductors.

15. The electrical connector of claim 14, wherein the ends of the ground conductors of the plurality of columns are connected to the conductive contact member.

16. The electrical connector of claim 14, wherein:
the center-to-center spacing of pairs of signal conductors along each of the plurality of columns is less than 2.5 millimeters.

17. The electrical connector of claim 14, wherein:
a linear density of pairs of signal conductors along each of the plurality of columns is approximately 60 pairs of signal conductors per centimeter.

18. The electrical connector of claim 14, wherein:
a density of pairs of signal conductors is approximately 5 pairs of signal conductors per cubic centimeter.

19. The electrical connector of claim 1, wherein:
the electrical connector provides a data rate between 32 Gb/s and 128 Gb/s.

20. An electrical assembly comprising:
a PCB; and
an electrical connector mated with the PCB through, the electrical connector comprising:
a mounting interface with the PCB;
a plurality of signal conductors, each of the plurality of signal conductors having an end at the mounting interface connected to the PCB;
a plurality of ground conductors, each of the plurality of ground conductors having an end at the mounting interface; and
a conductive contact member comprising a contact connected to a ground structure of the PCB;
wherein:
the ends of the plurality of ground conductors are connected to the conductive contact member such that the plurality of ground conductors are connected to the ground structure of the PCB through the conductive contact member.

21. The electrical assembly of claim 20, wherein:
the PCB comprises a plurality of openings; and
the ends of the plurality of signal conductors are engaged with the plurality of openings of the PCB.

22. The electrical assembly of claim 20, wherein:
the ground structure of the PCB comprises a surface of the PCB; and
the contact is pressed against the surface of the PCB.

23. The electrical assembly of claim 20, wherein:
the PCB comprises a plurality of openings;
the electrical connector comprises a plurality of ground structures with tails at the mounting interface with the PCB; and
tails of the plurality of ground structures are engaged with the plurality of openings of the PCB.

24. The electrical assembly of claim 20, wherein:
the plurality of signal conductors and the plurality of ground conductors are disposed in a plurality of columns with each column comprising pairs of conductive signal conductors with ground conductors of the plurality of ground conductors between the pairs of signal conductors.

25. The electrical assembly of claim 24, wherein the plurality of signal conductors are disposed in a plurality of openings of the PCB arranged in a plurality of columns.

26. The electrical assembly of claim 20, wherein the electrical connector further comprises:
a lossy member connected to the conductive contact member;
wherein the ends of the plurality of ground conductors are connected to the loss member.

27-70. (canceled)
